(19) United States
(12) Patent Application Publication
(10) Pub. No.: US 2010/0321355 A1
(43) Pub. Date: Dec. 23, 2010

(54) DISPLAY PANEL INCLUDING OPTICAL SENSOR, DISPLAY DEVICE USING THE DISPLAY PANEL AND METHOD FOR DRIVING DISPLAY PANEL INCLUDING OPTICAL SENSOR

(76) Inventors: Toshimitsu Gotoh, Osaka (JP); Kei Oyobe, Osaka (JP); Akizumi Fujioka, Osaka (JP); Akinori Kubota, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/866,386

(22) PCT Filed: Jan. 29, 2009
(86) PCT No.: PCT/JP2009/051456

§ 371 Date: Aug. 5, 2010

(30) Foreign Application Priority Data
Feb. 5, 2008 (JP) 2008-025484

(51) Int. Cl. G09G 5/00

(52) U.S. Cl. 345/207

(57) ABSTRACT

Provided are a display panel including an optical sensor that can correct output of an optical sensor according to a change in the environmental temperature, and a display device using the same. The display panel including an optical sensor has an active matrix substrate (100) having a pixel region (1) in which pixels are disposed in a matrix. An optical sensor (11) is formed in at least a portion of the pixels in the pixel region (1). The display panel including an optical sensor includes a temperature sensor (9) that detects the ambient temperature of the optical sensor (11), and a signal processing circuit (8) that corrects output of the optical sensor (11) according to the ambient temperature detected by the temperature sensor (9).

### TECHNICAL FIELD

The present invention relates to a display panel including an optical sensor having photodetection elements such as photodiodes in pixels and that can be utilized as a scanner or touch panel, a driving method for the same, and a display device using the display panel including an optical sensor.

### BACKGROUND ART

Conventionally, a display device with an image pick-up function has been proposed that can pick up an image of an object near the display due to including photodetection elements such as photodiodes in a pixel region (e.g., see Patent Document 1). The photodetection elements in the pixel region are formed on an active matrix substrate at the same time as well-known constituent elements such as signal lines, scan lines, TFTs (Thin Film Transistor), and pixel electrodes are formed using a well-known semiconductor process. Such display devices with an image pick-up function are envisioned to be used as display devices for bidirectional communication and display devices with a touch panel function.

In general, the output of photodetection elements such as photodiodes includes noise components due to various types of influence such as changes in the environmental temperature and the parasitic capacitance of signal wiring. In particular, in the case of photodiodes, the output current changes according to changes in the ambient temperature. In view of this, Patent Document 1 discloses a configuration in which light-shielded sensors are provided outside the pixel region in order to detect noise components. Light-shielded sensors are the same elements as the photodetection elements in the pixel region, but their light receiving faces are shielded so that light is not incident thereon. Since these light receiving faces are shielded from light, fluctuations in the output from the light-shielded sensors express noise components arising from changes in the environmental temperature and other influences. Accordingly, correcting the output of the photodetection elements in the pixel region with use of the output of the light-shielded sensors obtains sensor output in which the influence of noise components has been reduced.

In the conventional display device disclosed in Patent Document 1, light-shielded sensors are provided outside a display region along at least one of the four sides of the display region, as shown in FIGS. 1, 3, and 5 of Patent Document 1. Output signals of the light-shielded sensors are then used to correct imaging signals of image pick-up sensors disposed in the same rows or columns. For example, in the configuration disclosed in FIG. 1 of Patent Document 1, the output signal from the light-shielded sensor in the first row is subtracted from the imaging signal of the image pick-up sensor disposed in the first row of the display region, thus obtaining an imaging signal from which noise components have been removed.

Patent Document 1: JP 2007-81870A

### DISCLOSURE OF INVENTION

### Problem to be Solved by the Invention

In Patent Document 1, although noise components arising from heat and other factors are removed with use of light-shielded sensors, the output of the optical sensors is not corrected based on the results of directly detecting changes in the environmental temperature. Note that conventionally there is no known configuration in which a change in the environmental temperature is detected with use of a temperature sensor, and the output of an optical sensor is corrected according to the detection results.

An object of the present invention is to provide a display panel including an optical sensor in which the output of an optical sensor can be corrected according to a change in the environmental temperature, due to including a temperature sensor for detecting changes in the environmental temperature, and a display device using the same.

### Means for Solving Problem

In order to achieve the aforementioned object, a display panel including an optical sensor according to the present invention is a display panel including an optical sensor that has an active matrix substrate having a pixel region in which pixels are disposed in a matrix, an optical sensor being formed in at least a portion of the pixels in the pixel region, the display panel including an optical sensor including: a temperature sensor that detects an ambient temperature of the optical sensor; and a correction circuit that corrects output of the optical sensor according to the ambient temperature detected by the temperature sensor. Note that the correction circuit may be disposed in the panel (on the active matrix substrate), or may be disposed outside the panel.

Also, a display device according to the present invention includes the aforementioned display panel including an optical sensor according to the present invention.

### EFFECTS OF THE INVENTION

According to the present invention, it is possible to provide a display panel including an optical sensor in which the output of an optical sensor can be corrected according to a change in the environmental temperature, due to including a temperature sensor for detecting changes in the environmental temperature, and a display device using the same.

### BRIEF DESCRIPTION OF DRAWINGS

FIG. 1 is a block diagram showing a schematic configuration of an active matrix substrate included in a display panel including an optical sensor according to Embodiment 1 of the present invention.

FIG. 2A is a plan view showing a schematic configuration of a pixel in a pixel region.

FIG. 2B is a cross-sectional view taken along an arrow A-A′ in FIG. 2A.

FIG. 3 is an equivalent circuit diagram of an optical sensor according to Embodiment 1.

FIG. 4 is a block diagram showing a functional configuration of the display panel including an optical sensor according to Embodiment 1.

FIG. 5 is a graph showing temperature and sensor output voltage characteristics of an optical sensor.

FIG. 6 is a schematic diagram showing an example of a disposition of temperature sensors in a variation of the display panel including an optical sensor according to Embodiment 1 in which a plurality of temperature sensors are provided, and a distribution of regions that are corrected with use of the sensors.

FIG. 7A is a cross-sectional diagram showing an exemplary configuration of the display panel including an optical sensor according to Embodiment 1.

FIG. 7B is a cross-sectional diagram showing an exemplary configuration of the display panel including an optical sensor according to Embodiment 1.

FIG. 8 is a schematic diagram showing a configuration of a display panel including an optical sensor according to Embodiment 2 of the present invention.

FIG. 9 is a block diagram showing a functional configuration of the display panel including an optical sensor according to Embodiment 2.

FIG. 10 is a schematic diagram showing a variation of the display panel including an optical sensor according to Embodiment 2 of the present invention.

### DESCRIPTION OF THE INVENTION

A display panel including an optical sensor according to an embodiment of the present invention is a display panel including an optical sensor that has an active matrix substrate having a pixel region in which a plurality of pixels are disposed, an optical sensor being formed in at least a portion of the pixels in the pixel region, the display panel including an optical sensor including: a temperature sensor that detects an ambient temperature of the optical sensor; and a correction circuit that corrects output of the optical sensor according to the ambient temperature detected by the temperature sensor.

According to this configuration, the output of the optical sensor is corrected according to the ambient temperature detected by the temperature sensor, thus enabling the provision of a display panel including an optical sensor that is not influenced by fluctuations in the ambient temperature.

In the display panel including an optical sensor according to the aforementioned configuration, the temperature sensor may be disposed outside the active matrix substrate, or may be disposed outside the pixel region on the active matrix substrate.

Furthermore, a configuration is preferable in which a plurality of the temperature sensors are provided, the pixels in the pixel region are divided into groups respectively corresponding to the plurality of temperature sensors, and for each optical sensor in the pixels in each group, the correction circuit corrects the output of the optical sensor according to the ambient temperature detected by the temperature sensor corresponding to the group. According to this configuration, more accurate correction of the output of the optical sensor is possible even if the temperature distribution is not uniform.

Also, a display device according to an embodiment of the present invention has a configuration including the above display panel including an optical sensor.

Also, in order to achieve the aforementioned object, a driving method for a display panel including an optical sensor according to the present invention is a driving method for a display panel including an optical sensor that has an active matrix substrate having a pixel region in which a plurality of pixels are disposed, an optical sensor being formed in at least a portion of the pixels in the pixel region, the driving method including the step of correcting output of the optical sensor according to an ambient temperature detected by a temperature sensor that detects an ambient temperature of the optical sensor.

In the aforementioned driving method, it is preferable that a plurality of temperature sensors are used as the temperature sensor, the pixels in the pixel region are divided into groups respectively corresponding to the plurality of temperature sensors, and for each optical sensor in the pixels in each group, the output of the optical sensor is corrected according to the ambient temperature detected by the temperature sensor corresponding to the group.

Below is a description of more specific embodiment of the present invention with reference to the drawings. Note that although an exemplary configuration in the case in which a display device according to the present invention is implemented as a liquid crystal display device is described in the following embodiments, the display device according to the present invention is not limited to a liquid crystal display device, but instead is applicable to an arbitrary display device that uses an active matrix substrate. Note that due to having an image pick-up function, the display device according to the present invention is envisioned to be used as a display device with a touch panel in which input operations are performed by detecting an object near the screen, a scanner that reads an image of a document or the like that is placed on the screen, a display device for bidirectional communication that is equipped with a display function and an imaging function, or the like.

Also, for the sake of convenience in the description, the drawings referenced below have been simplified so as to show only main members that are necessary for describing the present invention, among the constituent members of the embodiments of the present invention. Accordingly, the display device according to the present invention can include arbitrary constituent members that are not shown in the drawings referenced in the present specification. Also, the dimensions of the members in the drawings are not shown faithfully to the actual dimensions of the constituent members, the ratio of dimensions between the members, and the like.

### Embodiment 1

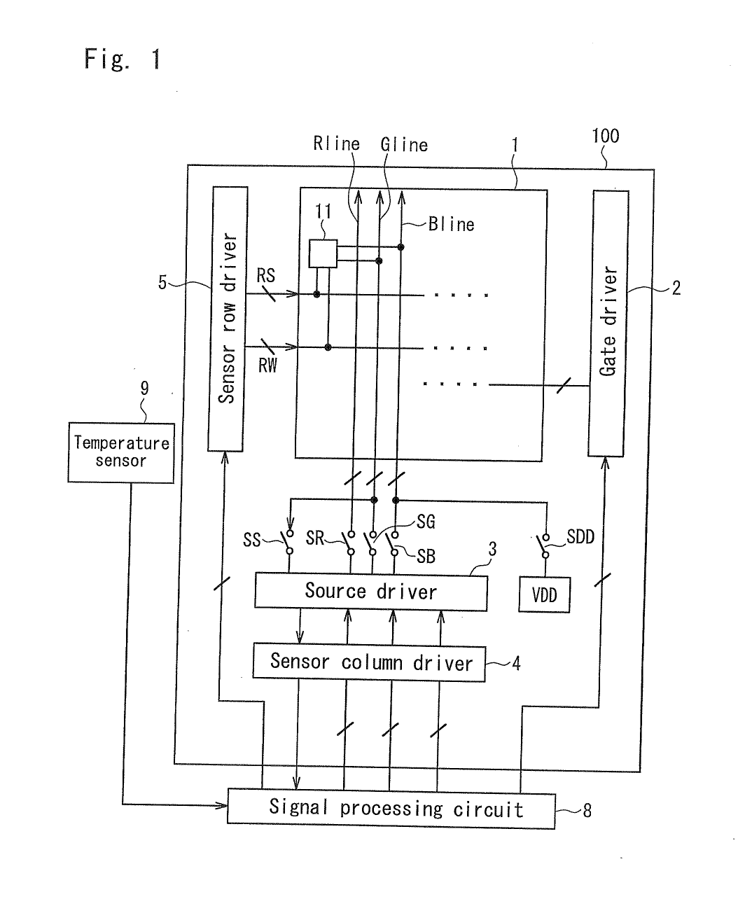

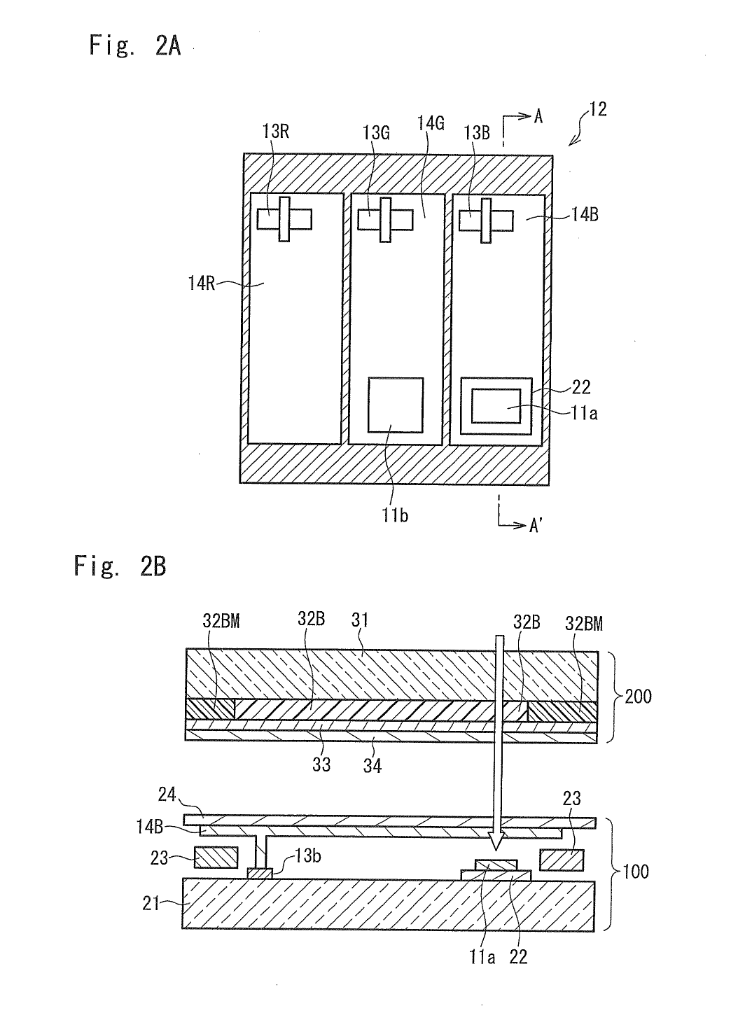

First is a description of a configuration of a display panel including an optical sensor that is included in a liquid crystal display device according to Embodiment 1 of the present invention with reference to FIGS. 1 and 2.

FIG. 1 is a block diagram showing a schematic configuration of an active matrix substrate 100 that is included in the display panel including an optical sensor according to the present embodiment. As shown in FIG. 1, the active matrix substrate 100 includes, on a glass substrate (not shown), at least a pixel region 1 in which pixels are disposed in a matrix, a display gate driver 2, a display source driver 3, a sensor column driver 4, and a sensor row driver 5. Note that the pixel disposition in the pixel region 1 does not necessarily need to be a matrix. Also, a signal processing circuit 8 for generating a signal for driving the pixels in the pixel region 1 and for processing sensor output from an optical sensor 11 in the pixel region 1 is connected to the active matrix substrate 100 via an FPC connector and an FPC (neither of which is shown). Furthermore, a temperature sensor 9 for measuring the environmental temperature (ambient temperature) is provided outside the active matrix substrate 100. There is no particular limitation on the position where the temperature sensor 9 is provided as long as the position is in the proximity of the active matrix substrate 100 such that temperature changes in the periphery of the optical sensor 11 can be reliably measured. For example, the temperature sensor 9 may be provided on a portion of a housing that holds together the active matrix substrate 100 and a counter substrate (described later). The output of the temperature sensor 9 is sent to the signal processing circuit 8.

The aforementioned constituent members on the active matrix substrate 100 can also be formed monolithically on a glass substrate by a semiconductor process. Alternatively, a configuration is possible in which amplifiers and the drivers among the aforementioned constituent elements are implemented on a glass substrate by COG (Chip On Glass) technology or the like. As another alternative, at least a portion of the aforementioned constituent members shown on the active matrix substrate 100 in FIG. 1 can be mounted on the FPC.

The pixel region 1 is a region where a plurality of pixels are disposed in a matrix. In the present embodiment, one optical sensor 11 is provided in each of the pixels in the pixel region 1. However, the embodiment of the present invention is not limited to this, and a configuration is possible in which optical sensors are provided in a portion of the pixels in the pixel region 1.

FIG. 2A is a plan view showing a schematic configuration of a pixel 12 in the pixel region 1. FIG. 2B is a cross-sectional view taken along an arrow A-A in FIG. 2A. In the example shown in FIG. 2A, the pixel 12 is formed by three picture elements, namely a red picture element, a green picture element, and a blue picture element. The red picture element has a TFT 13R and a pixel electrode 14R that is driven by the TFT 13R. A red color filter is disposed in a layer above the pixel electrode 14R. Similarly, the green picture element has a pixel electrode 14G that is driven by a TFT 13G, and a green color filter is disposed in a layer above the pixel electrode 14G. Also, the blue picture element has a pixel electrode 14B that is driven by a TFT 13B, and a blue color filter 32B (see FIG. 2B) is disposed in a layer above the pixel electrode 14B.

In the pixel 12, a photodiode 11a that is the photodetection element of the optical sensor 11 is formed in the blue picture element. Also, an output circuit 11b (described in detail later) for reading an electrical charge from the photodiode 11a and generating sensor output is formed in the green pixel. The photodiode 11a is formed on the active matrix substrate 100 at the same time as the TFTs 13R, 13G, and 13B, by the semiconductor process for forming these TFTs. Note that although FIG. 2A shows an example of a configuration in which the photodiode 11a is formed in the blue picture element and the output circuit 11b is formed in the green picture element, the photodiode 11a may be formed in any picture element in the pixel 12.

Note that as shown in FIG. 2B, the photodiode 11a is formed on a glass substrate 21 of the active matrix substrate 100, with a light shielding layer 22 therebetween. The light shielding layer 22 is provided in order to prevent light from a backlight (not shown) disposed on the back face of the glass substrate 21 from being incident on the photodiode 11a.

In FIG. 2B, 23 denotes a gate metal, and 24 denotes an insulating film. The active matrix substrate 100 is attached to a counter substrate 200 having a counter electrode 33 and an oriented film 34 formed on the entire face thereof, and a liquid crystal material (not shown) is enclosed in the gap therebetween. The counter substrate 200 has, on a glass substrate 31, a color filter layer 32 that is configured by a black matrix 32BM, a blue color filter 32B, and a red color filter and green color filter not shown in FIG. 2B. Note that the region with diagonal hatching in FIG. 2A is the region covered by the black matrix 32BM in FIG. 2B.

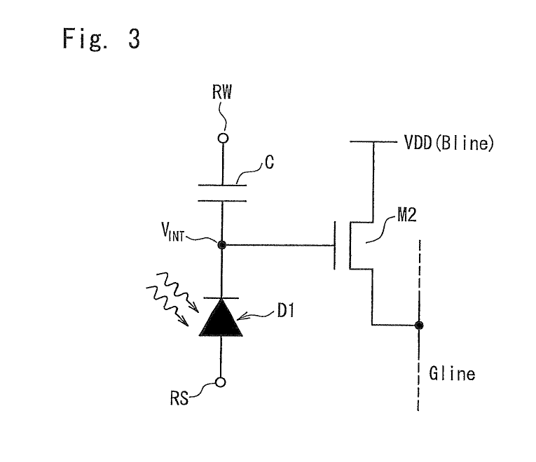

Below is a description of the structure and operations of the optical sensors 11 provided one each in the pixels 12 in the pixel region 1, with reference to FIGS. 1 and 3. FIG. 3 is an equivalent circuit diagram of the optical sensor 11. As shown in FIG. 3, the optical sensor 11 has a photodiode D1 (the photodiode 11a shown in FIG. 2), a capacitor C, and a sensor preamplifier M2. Specifically, the capacitor C and the sensor preamplifier M2 are included in the output circuit 11b shown in FIG. 2A. The anode of the photodiode D1 is connected to the sensor row driver 5 via a reset line RS.

The cathode of the photodiode D1 is connected to one of the electrodes of the capacitor C. The other electrode of the capacitor C is connected to the sensor row driver 5 via a readout signal line RW. Note that although the number of pairs of reset lines RS and readout signal lines RW is equal to the number of pixels in the row direction in the pixel region 1 in the present embodiment, this number of pairs does not necessarily need to be equal to such number of pixels. In other words, an optical sensor 11 and a pair of a reset line RS and a readout signal line RW for driving the optical sensor 11 may be provided one for every few lines.

As shown in FIGS. 1 and 3, the cathode of the photodiode D1 is connected to the gate of the sensor preamplifier M2. The source of the sensor preamplifier M2 is connected to a source line Bline for driving the blue picture element (described later). The drain of the sensor preamplifier M2 is connected to a source line Gline for driving the green picture element (described later). In a writing period for the picture elements, switches SR, SG, and SB that carry output from the source driver 3 to a source line Rline for driving the red picture element (described later) and the source lines Gline and Bline are turned on, and a switch SS and a switch SDD are turned off. Accordingly, image signals from the source driver 3 are written to the picture elements. On the other hand, in a predetermined period (sensing period) between writing periods, the switches SR, SG, and SB are turned off, and the switch SS and the switch SDD are turned on. The switch SS connects the drain of the sensor preamplifier M2 and the source line Gline to the sensor column driver 4. The switch SDD connects a constant voltage source VDD to the Bline. Note that although an example of a configuration in which the source lines Gline and Bline also play the role of driving lines for the sensor preamplifier M2 is shown in FIGS. 1 and 3, which source lines are used as the driving lines for the sensor preamplifier M2 is arbitrary design matter. Also, instead of the source lines also playing the role of driving lines for the sensor amplifier M2, a configuration is possible in which a driving line for the sensor preamplifier M2 is provided separately from the source lines.

In the optical sensor 11, the sensing period is started due to the supply of a reset signal from the reset line RS. After the start of sensing, a potential VINT of the cathode of the photodiode D1 of the optical sensor 11 decreases according to the amount of received light. Thereafter, due to the supply of a readout signal from the readout signal line RW, the potential VINT of the photodiode D1 at that time is read out, and is then amplified by the sensor amplifier M2.

The output (sensor output) from the sensor preamplifier M2 is sent to the sensor column driver 4 via the signal line Gline. The sensor column driver 4 further amplifies the sensor output, and outputs the resulting sensor output to the signal processing circuit 8. In the signal processing circuit 8, desired image processing is performed based on position information of the optical sensor 11 in the pixel region 1 and the sensor output of the optical sensor 11. For example, in the case of using the display panel including an optical sensor according to the present embodiment in a touch panel, the signal processing circuit 8 performs processing for recognizing which portion of the pixel region 1 has been touched based on the position information and the sensor output. Also, in the exemplary case of using the display panel including an optical sensor according to the present embodiment in a scanner, the signal processing circuit 8 performs image reading based on the position information and the sensor output.

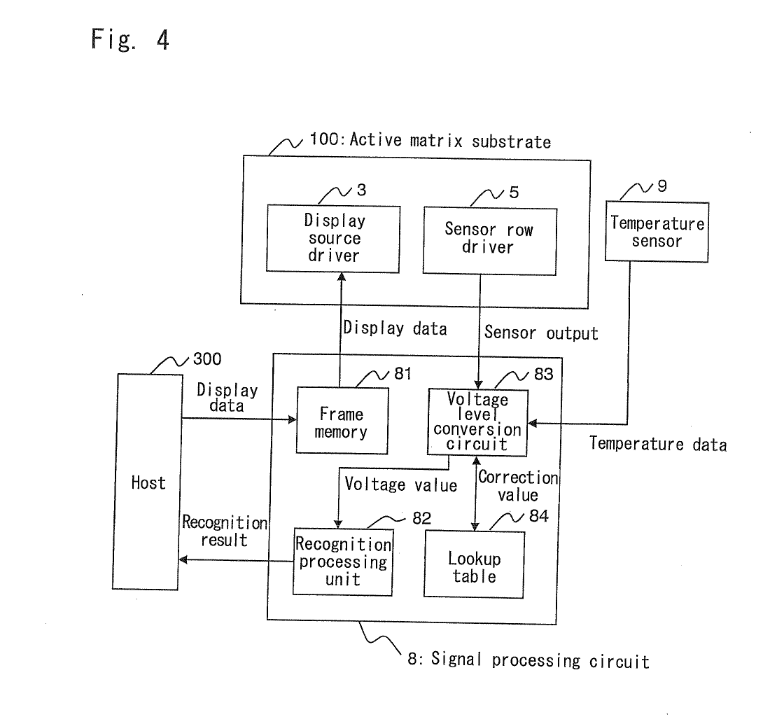

Below is a description of mainly a functional configuration of the signal processing circuit 8 with reference to FIG. 4. FIG. 4 is a block diagram showing a functional configuration of the display panel including an optical sensor according to the present embodiment. Note that although FIG. 4 shows an exemplary configuration in the case of using the display panel including an optical sensor according to the present embodiment in a touch panel, as described above the internal configuration of the signal processing circuit 8 can be arbitrarily designed according to the application of the display panel including an optical sensor according to the present embodiment. Also, FIG. 4 shows only the display source driver 3 and the sensor row driver 5 among the constituent elements in the active matrix substrate 100, and the other elements have been omitted from the depiction.

As shown in FIG. 4, the signal processing circuit 8 includes a frame memory 81, a recognition processing unit 82, a voltage level conversion unit 83, and a lookup table 84. The frame memory 81 is a memory that stores, in units of frames, display data input from a host 300. Note that the host 300 is a processor that generates display data and performs various types of processing with use of recognition results obtained by the touch panel. The host 300 is, in some cases, provided inside a display device including the display panel including an optical sensor according to the present embodiment, and in some cases provided outside the display device. The recognition processing unit 82 performs processing for recognizing which portion of the pixel region 1 has been touched based on the position information of the optical sensor 11 in the pixel region 1 and the sensor output of the optical sensor 11, as previously described. Note that the recognition processing unit 82 houses a memory (not shown) for performing such processing. The recognition results are output from the recognition processing unit 82 to the host 300.

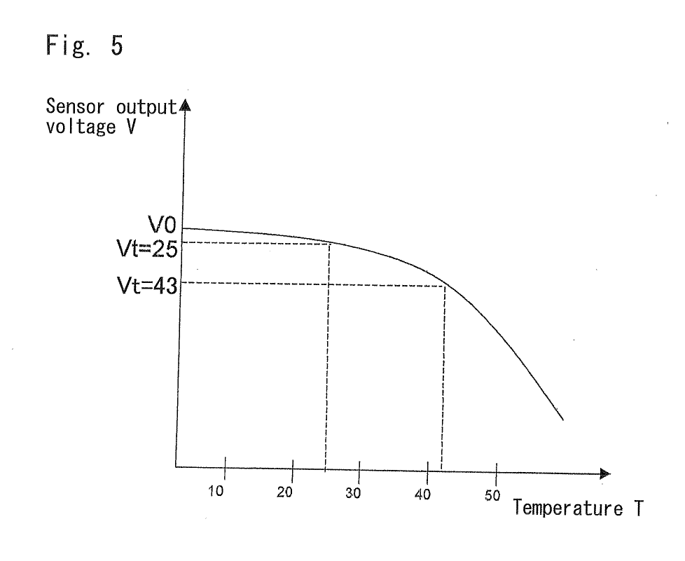

The voltage level conversion unit 83 references the lookup table 84 based on temperature data from the temperature sensor 9, and corrects sensor output according to a detected temperature t obtained by the temperature sensor 9. The lookup table 84 is a table that prescribes a correspondence relationship between detected temperatures t and sensor output voltages. Specifically, as shown in FIG. 5, even if the amount of received light (tone) of the output sensor 11 is a predetermined value, the sensor output voltage from the output sensor 11 changes according to the ambient temperature. For example, in the case in which the detected temperature t obtained by the temperature sensor 9 is 25° C., the sensor output voltage corresponding to a certain tone is Vₜ₌₂₅ as shown in FIG. 5, whereas if the detected temperature t is 43° C., the sensor output voltage corresponding to the same tone decreases to Vₜ₌₄₃. Accordingly, it is sufficient for the lookup table 84 to store the correspondence relationship between detected temperatures t and change amounts (i.e., correction amounts) for sensor output voltages, using, for example, the sensor output voltage in the case in which the detected temperature t is 25° C. as the reference, as shown in FIG. 5. For example, in the example shown in FIG. 5, it is sufficient to store the value of Vₜ₌₂₅−Vₜ₌₄₃ in the lookup table 84 as the correction value in the case in which the detected temperature t is 43° C.

For example, if the detected temperature t is 25° C., the voltage level conversion unit 83 outputs the voltage value of the sensor output voltage as is. On the other hand, if the detected temperature t is 43° C. for example, the voltage level conversion unit 83 corrects the sensor output voltage by reading out the value stored in the lookup table 84 as the correction value in the case in which the detected temperature t is 43° C., and subtracting the correction value from the sensor output voltage. The voltage level conversion unit 83 then outputs the obtained voltage value to the recognition processing unit 82.

Note that although 25° C. is used as the reference for detected temperatures t in the aforementioned example, the reference temperature is not limited to this. Also, instead of storing differences from a sensor output voltage corresponding to a reference temperature in the lookup table 84, sensor output voltages corresponding to ambient temperatures may be stored. In this case, it is sufficient for the voltage level conversion unit 83 to be able to appropriately set the reference temperature and use, as the correction values, values obtained by subtracting sensor output voltages corresponding to detected temperatures t obtained by the temperature sensor from a sensor output voltage corresponding to the reference temperature.

Also, since the change in sensor output voltages is not linear with respect to changes in the ambient temperature as is evident in FIG. 5, the lookup table 84 preferably stores corresponding sensor output voltages for a plurality of values (as many values as possible) of the detected temperature t obtained by the temperature sensor 9.

Note that in the present embodiment, an example of a configuration has been given in which the voltage level conversion unit 83 references the lookup table 84 in order to obtain a correction value corresponding to a detected temperature t. However, a correction value can be obtained without using a lookup table. For example, a configuration is possible in which an approximate equation of the temperature-sensor output voltage characteristics curve shown in FIG. 5 is stored in advance, and a correction value is obtained by substituting a detected temperature t into the approximate equation.

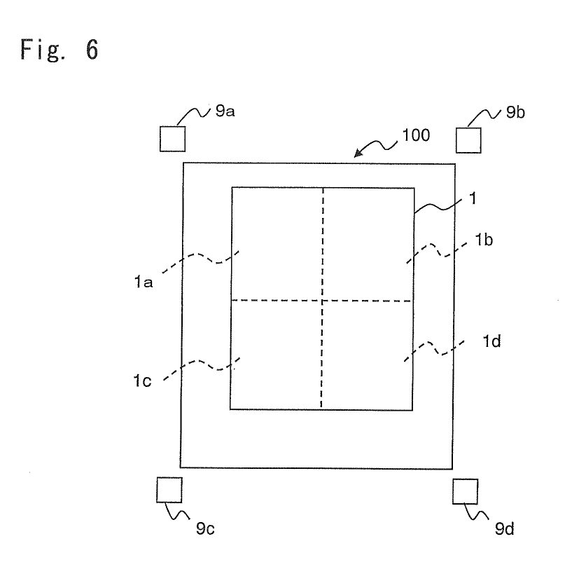

Also, in the above embodiment, an example of a configuration has been given in which one temperature sensor 9 is provided (see FIG. 1). However, a configuration in which a plurality of temperature sensors 9 are provided in the proximity of the active matrix substrate 100 is also an embodiment of the present invention. For example, a configuration is possible in which a total of four temperature sensors 9 (temperature sensors 9a to 9d in FIG. 6) are provided in the proximity of the four corners of the active matrix substrate 100, as shown in FIG. 6. Note that a depiction of constituent elements other than the pixel region 1 on the active matrix substrate 100 has been omitted from FIG. 6.

In the above case, the pixel region 1 is divided in four regions, namely regions 1a to 1d, as shown by broken lines in FIG. 6. The sensor output voltage of the optical sensor 11 in the pixel region 1a is then corrected according to a detected temperature from the temperature sensor 9a. It is preferable that, in the same way, the sensor output voltages of the optical sensors 11 in the pixel regions 1b, 1c, and 1d are corrected according to detected temperatures from the temperature sensors 9b, 9c, and 9d respectively. This configuration enables more accurately correcting the sensor output voltages of the optical sensors 11 according to localized temperature changes, compared to a configuration in which only one temperature sensor 9 is provided.

Note that in the case of providing a plurality of temperature sensors 9, needless to say, the number of temperature sensors provided is not limited to being only four as shown in FIG. 6. Also, the positions where the temperature sensors 9 are disposed do not necessarily need to be symmetrical. Furthermore, in the case of dividing the pixel region according to a plurality of temperature sensors, the sizes of the divided regions do not necessarily need to be equal. For example, it is conceivable to dispose temperature sensors more densely in the proximity of places where the temperature gradient is steep in the active matrix substrate 100 than places where the temperature gradient is gentle. In this way, the sizes of the regions in which optical sensor output is corrected according to detected temperatures from temperature sensors are caused to be smaller in places where the temperature gradient is steep than in places where the temperature gradient is gentle, and thus the sensor output voltages of the optical sensors 11 can be more accurately corrected according to localized temperature changes.

As described above, the display panel including an optical sensor according to the present embodiment is configured such that the temperature sensor 9 detects the ambient temperature in the proximity of the active matrix substrate 100 provided with the optical sensor 11, and the output voltage of the optical sensor 11 is corrected based on the detected temperature. This enables the realization of a display panel including an optical sensor that is not influenced by fluctuations in the ambient temperature.

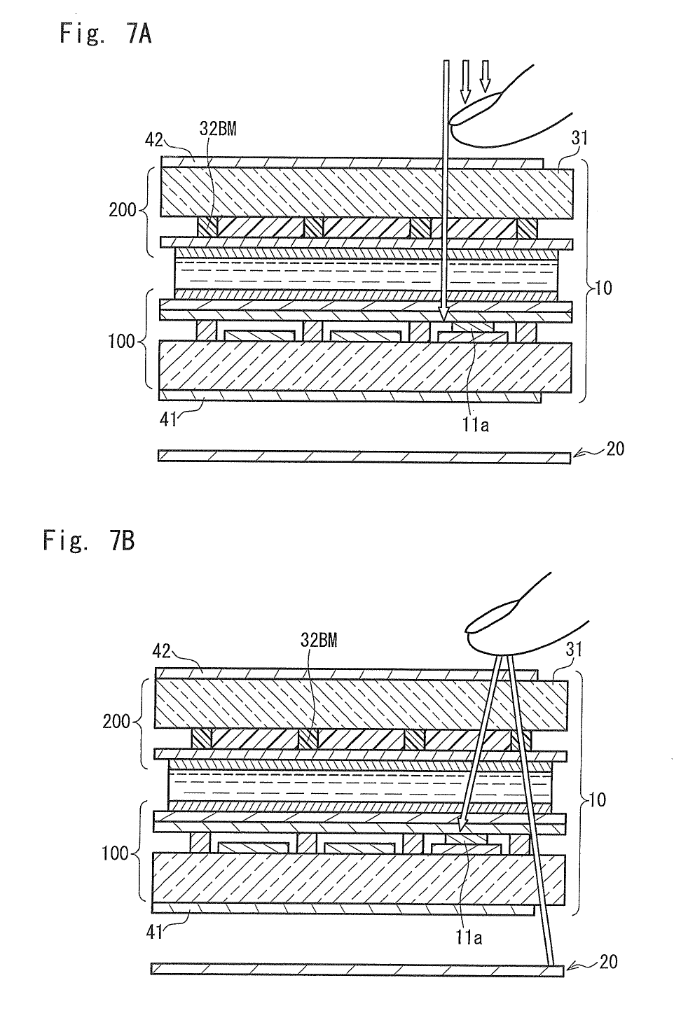

Note that as shown in FIGS. 7A and 7B, a display panel including an optical sensor 10 according to the present embodiment is configured by attaching the active matrix substrate 100 to the counter substrate 200, and filling the gap therebetween with liquid crystal. A backlight 20 is disposed on the back face of the display panel including an optical sensor 10, thus configuring a transmissive-type liquid crystal display device. Note that a pair of polarizing plates 41 and 42 that function as a polarizer and a photodetector, various types of optical compensation films, and the like are disposed on both faces of the display panel including an optical sensor 10. Note that in order to facilitate understanding of the structure, FIGS. 7A and 7B are enlarged views of the internal configuration of the display panel including an optical sensor 10.

Due to the optical sensor 11 disposed in the pixel region 1, this transmissive-type liquid crystal display device functions as a display device with an image reading function such as a touch panel or a scanner. Note that in the case in which the transmissive-type liquid crystal display device is configured as a touch panel, a configuration is possible in which, as shown in FIG. 7A, a shadow image formed due to external light (an image that is darker than the surrounding) is detected when an object such as a person's finger is near the display panel screen, and a configuration is possible in which, as shown in FIG. 7B, a reflected image (an image brighter than the surrounding) formed due to exiting light from the backlight 20 being reflected by an object is detected. In this way, whether a shadow image or a reflected image is to be detected is determined by a signal processing method in the recognition processing unit 82 of the signal processing circuit 8. Accordingly, a configuration is also possible in which the processing performed by the recognition processing unit 82 of the signal processing circuit 8 is switched between a shadow image detection mode and a reflected image detection mode.

### Embodiment 2

Next is a description of a configuration of a display panel including an optical sensor that is included in a liquid crystal display device according to Embodiment 2 of the present invention. Note that portions of the configuration that are similar to portions in the configuration described in Embodiment 1 have been given the same reference numerals as in Embodiment 1, and detailed descriptions thereof have been omitted.

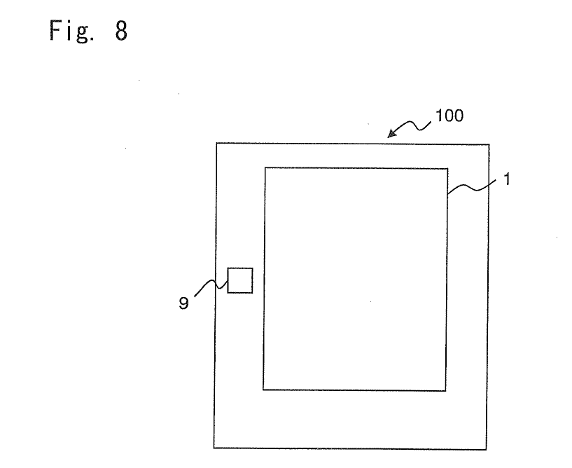

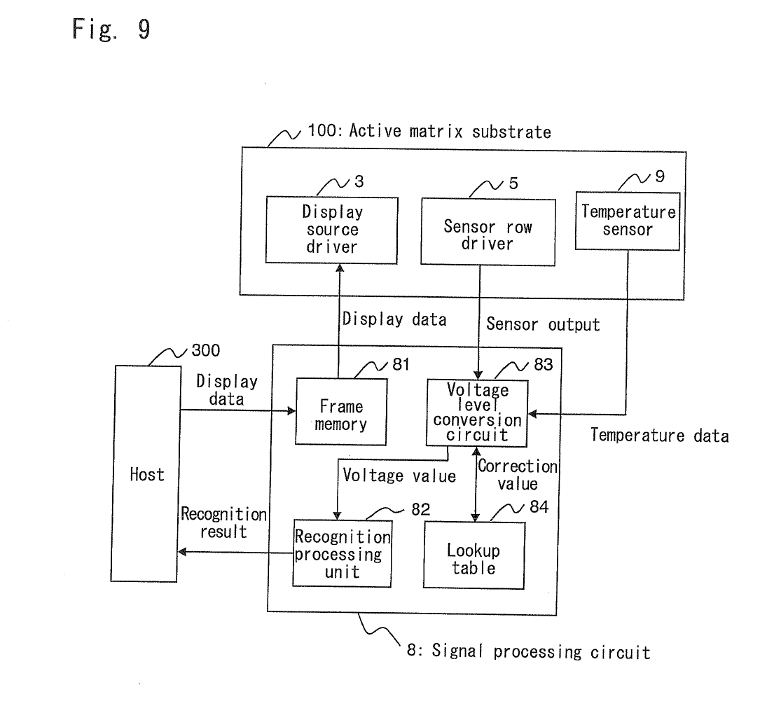

As shown in FIGS. 8 and 9, the display panel including an optical sensor according to the present embodiment differs from Embodiment 1 in that the temperature sensor 9 is provided on the glass substrate of the active matrix substrate 100. The temperature sensor 9 is mounted on the glass substrate with use of COG (Chip On Glass) technology or the like. Alternatively, a configuration is possible in which instead of directly measuring temperatures using the temperature sensor 9, an optical sensor that is shielded from light is used as the temperature sensor 9, and the temperature is calculated from the output of the optical sensor. In other words, this is because fluctuations in the output of the light-shielded optical sensor express fluctuations in the ambient temperature of the optical sensor.

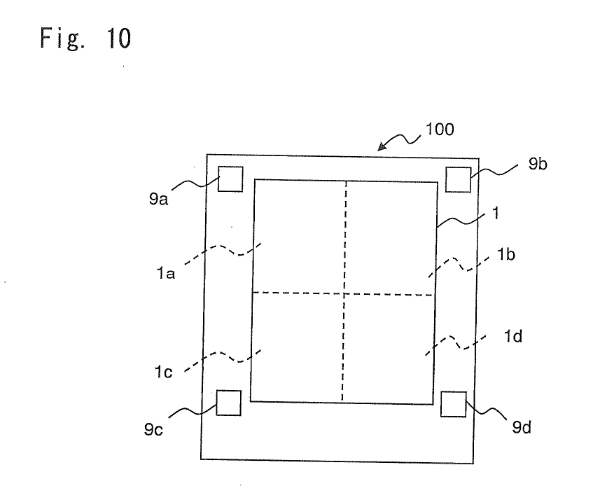

Note that similarly to Embodiment 1, the number of temperature sensors 9 is arbitrary. Specifically, a configuration is possible in which only one temperature sensor 9 is provided as shown in FIG. 8, and a configuration is possible in which a plurality of temperature sensors 9 are provided on the glass substrate of the active matrix substrate 100 as shown in FIG. 10. In the configuration shown in FIG. 10, four temperature sensors 9 (temperature sensors 9a to 9d) are disposed in the proximity of the four corners of the pixel region 1, in the region outside the pixel region 1 of the active matrix substrate 100. Also, the pixel region 1 is divided into four sub regions (pixel regions 1a to 1d), and the temperature sensor 11 in the pixel region 1a is corrected based on a detected temperature from the temperature sensor 9a. Also, the optical sensors 11 in the pixel regions 1b to 1d are corrected based on detected temperatures from the temperature sensors 9b to 9d respectively. Note that a description of the correction technique has been omitted due to being similar to that in Embodiment 1.

As described above, similarly to Embodiment 1, the present embodiment enables detecting the ambient temperature with use of the temperature sensor 9 provided on the active matrix substrate 100, and correcting the output voltage of the optical sensor 11 based on the detected temperature. This enables the provision of a display panel including an optical sensor and a display device using the same that are not influenced by fluctuations in the ambient temperature. Also, in the present embodiment, the pixel region 1 is divided into a plurality of sub regions, and optical sensor output in the sub regions is corrected based on detected temperatures from the respective temperature sensors disposed in the proximity of the divided sub regions. This enables correcting optical sensor output in accordance with temperature variations on the active matrix substrate 100. Note that in the configuration of the present embodiment as well, the positions where the temperature sensors 9 are disposed do not necessarily need to be symmetrical. Also, the sizes of the sub regions of the pixel region 1 do not necessarily need to be equal.

Although an embodiment of the present invention has been described above, the present invention is not limited to only the above-described concrete example, and various modifications within the scope of the invention are possible.

Also, in the above embodiments, examples of configurations have been given in which every pixel is provided with one optical sensor 11. However, an optical sensor does not necessarily need to be provided in every pixel. For example, a configuration is possible in which optical sensors are formed in every other row or every other column, and such a configuration is also included in the technical scope of the present invention.

Also, although the three RGB picture elements form each pixel in the present embodiment, the configuration of the pixels is not limited to this. Each pixel may be formed by three or more picture elements, and a configuration is possible in which one picture element corresponds to one pixel, such as with a monochrome display panel.

### INDUSTRIAL APPLICABILITY

The present invention is industrially applicable as a display panel including an optical sensor that has an optical sensor, and a display device using the same.

1. A display panel including an optical sensor that has an active matrix substrate having a pixel region in which a plurality of pixels are disposed, an optical sensor being formed in at least a portion of the pixels in the pixel region, the display panel including an optical sensor comprising:
a temperature sensor that detects an ambient temperature of the optical sensor; and
a correction circuit that corrects output of the optical sensor according to the ambient temperature detected by the temperature sensor.

2. The display panel including an optical sensor according to claim 1, wherein the temperature sensor is disposed outside the active matrix substrate.

3. The display panel including an optical sensor according to claim 1, wherein the temperature sensor is disposed outside the pixel region on the active matrix substrate.

4. The display panel including an optical sensor according to claim 1, comprising a plurality of the temperature sensors,
wherein the pixels in the pixel region are divided into groups respectively corresponding to the plurality of temperature sensors, and
for each optical sensor in the pixels in each group, the correction circuit corrects the output of the optical sensor according to the ambient temperature detected by the temperature sensor corresponding to the group.

5. A display device comprising the display panel including an optical sensor according to claim 1.

6. driving method for a display panel including an optical sensor that has an active matrix substrate having a pixel region in which a plurality of pixels are disposed, an optical sensor being formed in at least a portion of the pixels in the pixel region, the driving method comprising the step of:
correcting output of the optical sensor according to an ambient temperature detected by a temperature sensor that detects an ambient temperature of the optical sensor.

7. The driving method for a display panel including an optical sensor according to claim 6, wherein
a plurality of temperature sensors are used as the temperature sensor,
the pixels in the pixel region are divided into groups respectively corresponding to the plurality of temperature sensors, and
for each optical sensor in the pixels in each group, the output of the optical sensor is corrected according to the ambient temperature detected by the temperature sensor corresponding to the group.
